(19) United States
(12) Patent Application Publication
(10) Pub. No.: US 2007/0113344 A1
(43) Pub. Date: May 24, 2007

(54) Movable bed with an independent wheel suspension system

(76) Inventor: Jodie Linda Hurwitz, Dallas, TX (US)

Correspondence Address: DOCKET CLERK, P.O. DRAWER 800889, DALLAS, TX, 75380, US

(21) Appl. No.: 11/287,464

(22) Filed: Nov. 23, 2005

(51) Int. Cl. A61G 7/05

(52) U.S. Cl. 5/620; 5/600

(57) ABSTRACT

A movable bed with an independent wheel suspension system is disclosed. The movable bed of the invention comprises a plurality of wheel assemblies. A wheel assembly is attached to each of the four corners of a bed frame of the movable bed. Each wheel assembly comprises a bed wheel and a shock absorber. The shock absorber comprises a first end attached to the bed frame and a second end attached to a bed wheel. In one advantageous embodiment the shock absorber comprises a robust shock absorber of a type employed on an off-road bicycle. A pivotal wheel assembly is also disclosed that may be pivoted downwardly and locked into place with respect to the bed frame to provide the additional support for the bed frame.

### TECHNICAL FIELD OF THE INVENTION

The present invention relates generally to movable beds and, more particularly, to a system and method for providing an independent wheel suspension system for a movable bed.

### BACKGROUND OF THE INVENTION

In order to provide mobility most movable beds (e.g., hospital beds) are mounted on wheels or casters. Hospital bed wheels are usually provided with a locking mechanism so that the wheels are not able to rotate when the locking mechanism is engaged. When it is desired to move the hospital bed the locking mechanism on the wheels is disengaged and the wheel are able to rotate freely.

FIG. 1 illustrates a prior art hospital bed 100 showing the typical size and placement of the hospital bed wheels 110. Prior art hospital bed wheels 110 are connected directly to the hospital bed frame 120. Therefore, when a hospital bed wheel 110 rolls over an obstacle (e.g., a cable mounted on the floor or a threshold in a doorway) the wheel rises up over the front of the obstacle, passes over the top of the obstacle, and falls down behind the obstacle to impact the floor. Each of the hospital bed wheels 110 that pass over the obstacle transmits the impact directly to the bed frame 120.

If a patient is in the hospital bed when the hospital bed 100 is being moved and the wheels 110 of the hospital bed 100 pass over an obstacle on the floor, the patient will feel the impact when the wheels 110 of the hospital bed 100 hit the floor after passing over the obstacle. The impact is felt because the wheels 110 of the hospital bed 100 are directly connected to the bed frame 120. The forces that are experienced by the wheels 110 are directly transmitted to the bed frame 120 and to the patient.

For these reasons, it would be very advantageous to have a movable bed that would not allow the forces that are experienced by the wheels to be transmitted to the bed frame and to the patient. There is a need in the art for a hospital bed that is capable of protecting a patient in the bed from receiving impacts that occur due to a hospital bed moving over obstacles on a floor.

### SUMMARY OF THE INVENTION

To address the above-discussed deficiencies of the prior art, it is a primary object of the present invention to provide a movable bed (such as a hospital bed) that is capable of protecting a person in the bed from receiving impacts that occur due to the movable bed moving over obstacles on a floor.

The movable bed of the present invention comprises a bed frame and an independent wheel suspension system. The independent wheel suspension system comprises a plurality of wheel assemblies. A wheel assembly is attached to each of the four corners of the bed frame of the movable bed. Each wheel assembly comprises a bed wheel and a shock absorber. The shock absorber comprises a first end attached to the bed frame and a second end attached to a bed wheel. The shock absorber comprises a damping mechanism (e.g., a spring or a hydraulic liquid) that resists the vertical motion of the bed wheel when the bed wheel passes over an obstacle on the floor.

In one advantageous embodiment the shock absorber may comprise a robust shock absorber of a type that is often employed on an off-road bicycle.

The independent wheel suspension system of the present invention also comprises a pivotal wheel assembly that may be pivoted downwardly and locked into a down position with respect to the bed frame to provide the additional support for the bed frame. When the additional support is not required the pivotal wheel assembly may be unlocked and then pivoted upwardly and locked into an up position with respect to the bed frame. The pivotal wheel assembly does not touch the floor when it is pivoted upwardly and locked into its up position.

It is an object of the present invention to provide a movable bed that is capable of protecting a person in the bed from receiving impacts that occur due to the movable bed moving over obstacles on a floor.

It is another object of the present invention to provide a hospital bed that is capable of protecting a patient in the bed from receiving impacts that occur due to the hospital bed moving over obstacles on a floor.

It is also an object of the present invention to provide a movable bed that comprises a bed frame and an independent wheel suspension system.

It is another object of the invention to provide an improved wheel assembly for a movable bed.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise”, as well as derivatives thereof, mean inclusion without limitation; the term “or,” is inclusive, meaning and/or; “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 illustrates a perspective view of a prior art hospital bed;

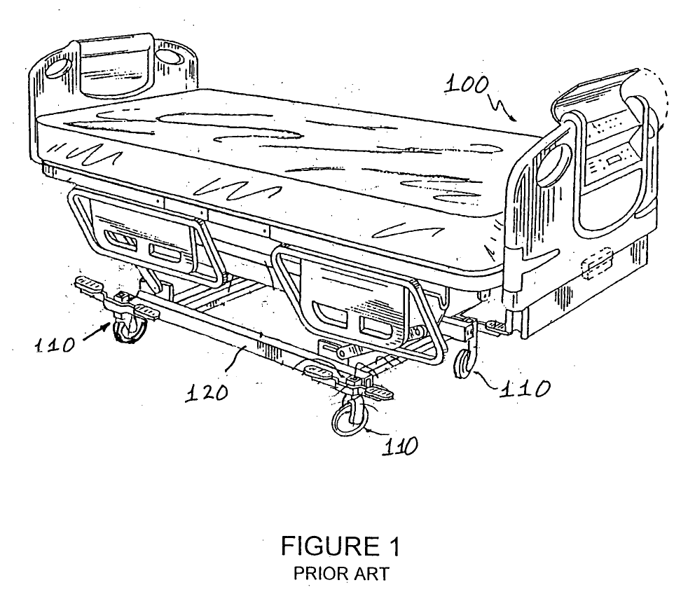

FIG. 2 illustrates side view of a hospital bed constructed in accordance with the principles of the present invention;

FIG. 3 illustrates a wheel assembly of the present invention;

FIG. 4 illustrates a shock absorber of the present invention;

FIG. 5 illustrates another advantageous embodiment of the hospital bed of the present invention;

FIG. 6 illustrates a method for manufacturing a hospital bed of the present invention; and

FIG. 7 illustrates a wheelchair constructed in accordance with the principles of the present invention.

### DETAILED DESCRIPTION OF THE INVENTION

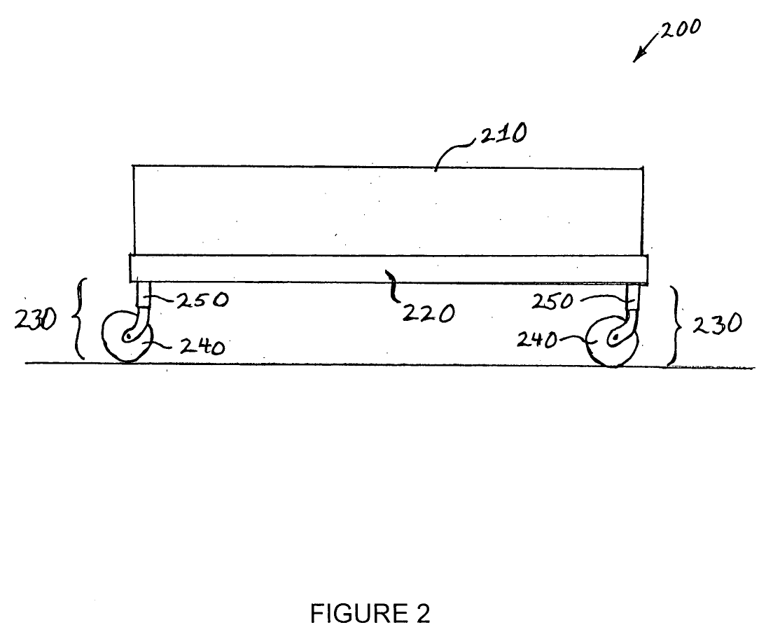

FIGS. 2 through 7, discussed below, and the various embodiments used to describe the principles of the present invention in this patent document are by way of illustration only and should not be construed in any way to limit the scope of the invention. Those skilled in the art will understand that the principles of the present invention may be implemented for any type of suitably arranged hospital bed.

FIG. 2 is a diagram 200 illustrating a side view of a hospital bed 210 that comprises a hospital bed frame 220 of the present invention. A wheel assembly 230 is attached to each of the four corners of bed frame 220. (Only two corners are shown in the side view of FIG. 2). A wheel assembly 230 comprises a hospital bed wheel 240 and a shock absorber 250. That is, each of the four wheels 240 in the wheel assemblies 230 that support bed frame 220 is attached to a shock absorber 250. When a wheel 240 passes over an obstacle (not shown in FIG. 2) the wheel 240 rises over the obstacle and falls down onto the floor after passing over the obstacle. Shock absorber 250 cushions the impact because each wheel 240 is directly connected to its own associated shock absorber 250. Each shock absorber 250 in a wheel assembly 230 is directly connected to the bed frame 220. The forces that are experienced by the wheels 240 are directly transmitted to the shock absorber 250.

Because of the cushioning effect of each shock absorber 250 a patient (not shown) in the bed 210 that is supported by bed frame 220 will not feel the impact when the wheels 240 of the hospital bed 210 hit the floor after passing over an obstacle. Shock absorber 250 may comprise one of a number of different types of shock absorber.

Each wheel 240 is connected to its own associated shock absorber 250. This feature provides independent wheel suspension for the hospital bed 210. Therefore a small obstacle that is encountered by only one wheel 240 will not affect the other wheels. The impact that is experienced by a single wheel that encounters a small obstacle will be cushioned by the shock absorber 250 that is associated with that single wheel. The other wheels will pass by the obstacle without hitting the obstacle.

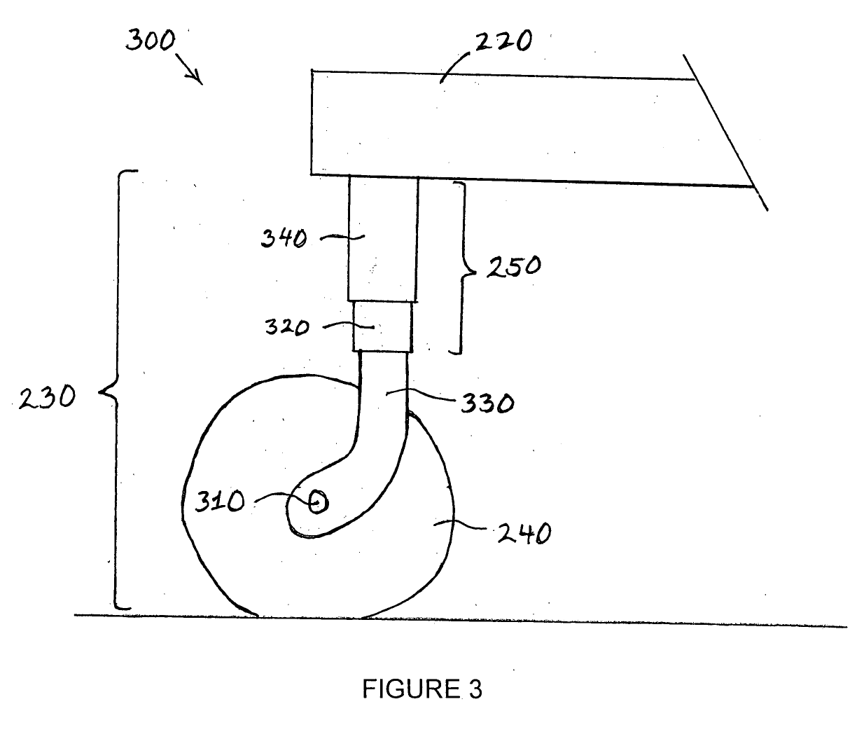

FIG. 3 is a diagram 300 illustrating a side view of a wheel assembly 230 of the present invention. Wheel assembly 230 comprises wheel 240 and shock absorber 250. An axle 310 of wheel 240 is connected via yoke 330 to an inner sliding tube 320 of shock absorber 250 at a first lower end of shock absorber 250. Bed frame 220 is connected to an outer tube 340 of shock absorber 250 at a second upper end of shock absorber 250.

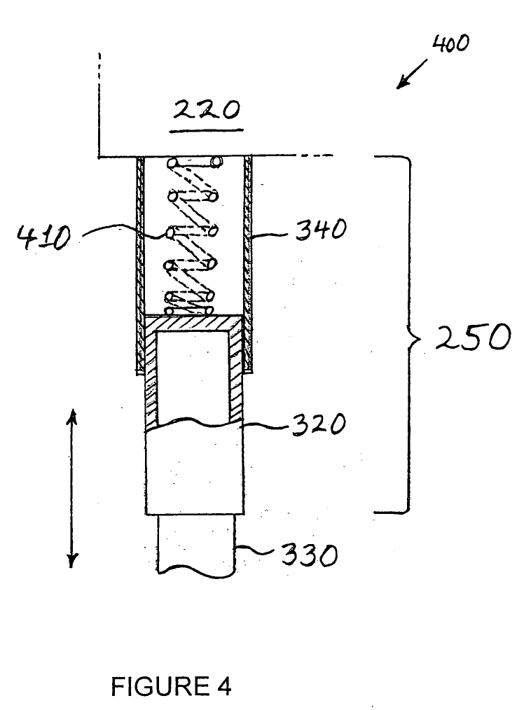

FIG. 4 is a diagram illustrating a cross sectional side view 400 of shock absorber 250. Wheel 240 (not shown in FIG. 4) is directly connected to the inner sliding tube 320 of the shock absorber 250 via axle 310 and yoke 330. Inner sliding tube 320 of shock absorber 250 is located within outer tube 340. Inner sliding tube 320 slides within outer tube 340. A damping mechanism 410 within shock absorber 250 mechanically resists the upward sliding motion of inner sliding tube 320 with respect to outer tube 340. The damping mechanism 410 of shock absorber 250 may comprise a spring, a hydraulic liquid, or other similar apparatus for providing resistance to mechanical motion. In FIG. 4 the damping mechanism 410 is shown as a spring 410.

In one advantageous embodiment of the invention, the shock absorber 250 comprises a robust shock absorber of the type that is employed on off-road bicycles known as “mountain bikes.” A robust shock absorber of this type is disclosed in U.S. Pat. No. 4,971,344.

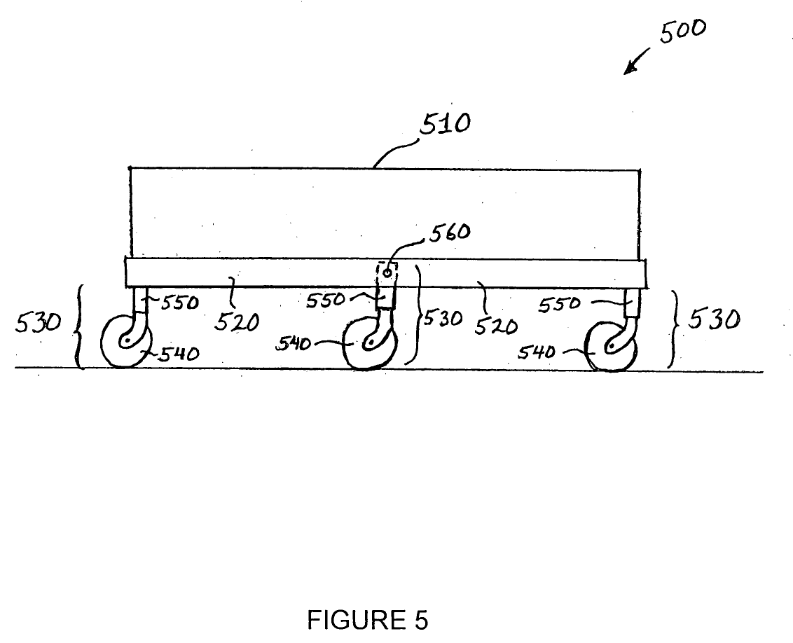

FIG. 5 is a diagram 500 illustrating another advantageous embodiment of the hospital bed 510 of the present invention. In this embodiment the hospital bed 510 comprises a hospital bed frame 520 to which five wheel assemblies 530 have been attached. (Only three wheel assemblies 530 are shown in the side view of FIG. 5). Each of the five wheel assemblies 530 comprises a wheel 540 and a shock absorber 550. The location of the fifth wheel assembly 530 may be selected to be at a central location under hospital bed 510. The presence of the fifth wheel assembly 530 provides additional support for a heavy load (e.g., an extremely obese patient).

In another advantageous embodiment of the invention, the fifth wheel assembly 530 may be pivotally attached to the bottom of the bed frame 520 by a pivot 560. The fifth wheel assembly 530 may be pivoted downwardly and locked into a first position in which the wheel 540 of the fifth wheel assembly 530 is in contact with the floor. The fifth wheel assembly 530 may also be pivoted upwardly and locked into a second position in which the wheel 540 of the fifth wheel assembly 530 is not in contact with the floor. In this manner, the fifth wheel assembly 530 may be used only when it is necessary to support a heavy load in the hospital bed 510.

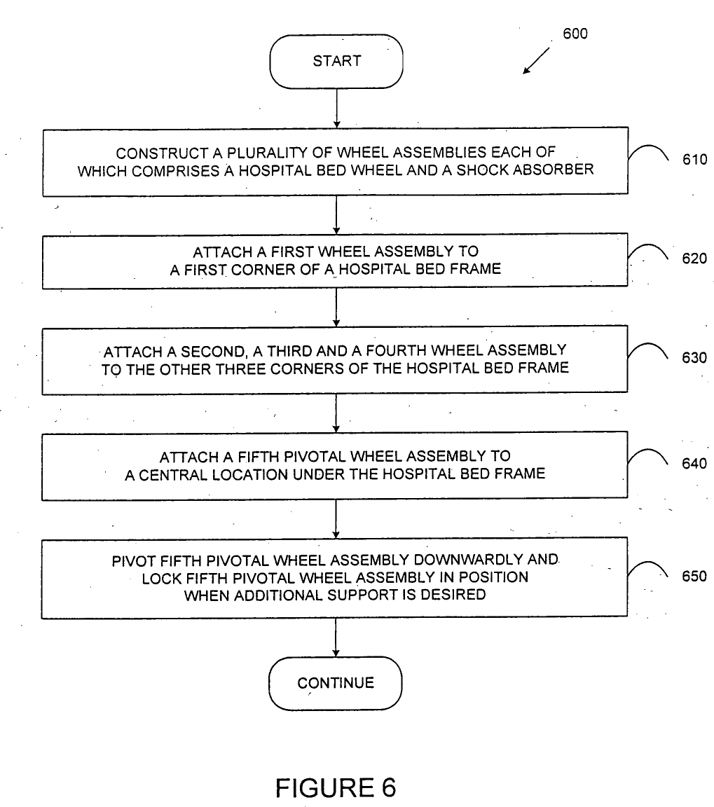

FIG. 6 is a flow chart 600 showing the steps of an advantageous embodiment of a method for manufacturing a hospital bed in accordance with the principles of the present invention. In the first step of the method, a plurality of wheel assemblies is constructed in which each wheel assembly comprises a hospital bed wheel and a shock absorber (step 610). In the second step of the method, a first wheel assembly is attached to a first corner of the hospital bed frame of a hospital bed (step 620).

In the third step of the method, a second, a third and a fourth wheel assembly is attached to each of the remaining three corners of the bed frame of the hospital bed (step 630). In the fourth step of the method, a fifth pivotal wheel assembly is attached to the hospital bed frame of the hospital bed at a central location under the hospital bed frame (step 640).

In the fifth step of the method, the fifth pivotal wheel assembly is pivoted downwardly and locked into position when it is desired to provide additional support for the hospital bed frame of the hospital bed (step 650).

Although the movable bed of the present invention has been described with reference to an embodiment that comprises a hospital bed, it is understood that the movable bed of the invention is not limited to a hospital bed. The hospital bed is only one example of a movable bed. The movable bed of the present invention may comprise an operating table, a gurney, a massage table, or any type of movable bed.

The independent wheel suspension system of the present invention may be attached to a bed frame of a bed when the bed is initially constructed. Alternatively, the independent wheel suspension system of the present invention may be used to retrofit a bed frame of a preexisting bed (either movable or non-movable). The old bed supports (wheels or legs) are removed from the bed frame and replaced with the independent wheel suspension system of the present invention. In this manner the benefits of the invention may be added to beds that already exist.

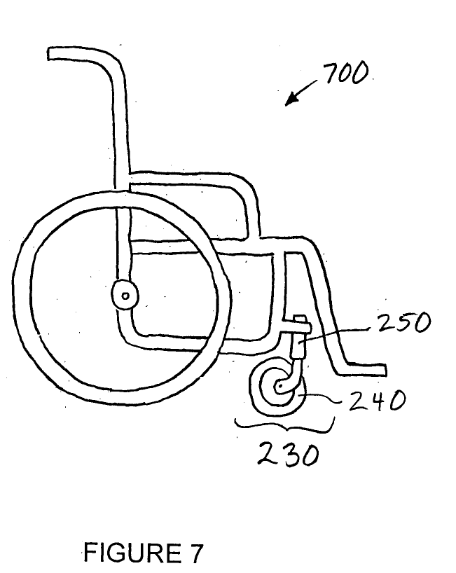

The independent wheel suspension system of the present invention may also be attached to a frame of a structure for moving persons who are not able to walk. For example, the independent wheel suspension system of the present invention may be attached to a wheelchair or similar type of structure. As previously described, the independent wheel suspension system of the present invention provides shock absorbers for that cushion impacts as the wheels pass over obstacles on the floor. FIG. 7 illustrates a wheelchair 700 that is equipped with the independent wheel suspension system of the present invention.

Although the present invention has been described with several embodiments, various changes and modifications may be suggested to one skilled in the art. It is intended that the present invention encompass such changes and modifications as fall within the scope of the appended claims.

What is claimed is:

1. A movable bed comprising:
a bed frame;
at least one a shock absorber having a first end attached to said bed frame; and
a bed wheel attached to a second end of said at least one shock absorber.

2. The movable bed set forth in claim 1 wherein said shock absorber comprises a damping mechanism for resisting vertical motion of said bed wheel, wherein said damping mechanism comprises one of: a spring and a hydraulic liquid.

3. The movable bed as set forth in claim 1 wherein said shock absorber comprises a robust shock absorber of a type employed on an off-road bicycle.

4. The movable bed as set forth in claim 1 further comprising a wheel assembly attached to each of four corners of said bed frame, wherein each wheel assembly comprises:
a bed wheel; and
a shock absorber having a first end attached to said bed frame and a second end attached to said bed wheel.

5. The movable bed set forth in claim 4 wherein each shock absorber in each wheel assembly comprises a damping mechanism for resisting vertical motion of a bed wheel, wherein said damping mechanism comprises one of: a spring and a hydraulic liquid.

6. The movable bed set forth in claim 4 wherein each shock absorber in each wheel assembly comprises a robust shock absorber of a type employed on an off-road bicycle.

7. The movable bed as set forth in claim 4 further comprising a fifth wheel assembly connected to said bed frame, wherein said fifth wheel assembly comprises:
a fifth bed wheel; and
a fifth shock absorber having a first end attached to said bed frame and a second end attached to said fifth bed wheel.

8. The movable bed as set forth in claim 7 wherein said fifth wheel assembly is pivotally connected to said bed frame.

9. The movable bed set forth in claim 7 wherein said fifth shock absorber in said fifth wheel assembly comprises a damping mechanism for resisting vertical motion of said fifth bed wheel, wherein said damping mechanism comprises one of: a spring and a hydraulic liquid.

10. The movable bed set forth in claim 7 wherein said fifth shock absorber in said fifth wheel assembly comprises a robust shock absorber of a type employed on an off-road bicycle.

11. A wheel assembly for use with a bed frame of a movable bed, said wheel assembly comprising:
a bed wheel; and
a shock absorber having a first end attached to said bed frame and a second end attached to said bed wheel.

12. The wheel assembly as set forth in claim 11 wherein said shock absorber comprises a damping mechanism for resisting vertical motion of said bed wheel, wherein said damping mechanism comprises one of: a spring and a hydraulic liquid.

13. The wheel assembly as set forth in claim 11 wherein said shock absorber comprises a robust shock absorber of a type employed on an off-road bicycle.

14. The wheel assembly as set forth in claim 11 wherein said wheel assembly is pivotally connected to said bed frame.

15. The wheel assembly as set forth in claim 14 wherein said wheel assembly one of: pivots downwardly and locks into a down position with respect to said bed frame, and pivots upwardly and locks into an up position with respect to said bed frame.

16. A method for providing a movable bed with an independent wheel suspension system, said method comprising the steps of:
providing a plurality of wheel assemblies, each of which comprises a bed wheel and a shock absorber; and
attaching each of said plurality of wheel assemblies to a location on a bed frame of said movable bed.

17. A method as set forth in claim 16, said method further comprising the steps of:
attaching a first wheel assembly to a first location on a bed frame of said movable bed;
attaching a second wheel assembly to a second location on said bed frame of said movable bed;
attaching a third wheel assembly to a third location on said bed frame of said movable bed; and
attaching a fourth wheel assembly to a fourth location on said bed frame of said movable bed.

18. The method as set forth in claim 16 wherein each shock absorber in each wheel assembly comprises a damping mechanism for resisting vertical motion of a bed wheel, wherein said damping mechanism comprises one of: a spring and a hydraulic liquid.

19. The method as set forth in claim 16 wherein each shock absorber in each wheel assembly comprises a robust shock absorber of a type employed on an off-road bicycle.

20. The method as set forth in claim 17 further comprising the steps of:
attaching a pivotal fifth wheel assembly to a fifth location on said bed frame of said movable bed;
pivoting said pivotal fifth wheel assembly downwardly with respect to said bed frame; and
locking said pivotal fifth wheel assembly in a down position with respect to said bed frame.

21. A method for providing an independent wheel suspension system for a structure for moving persons who are not able to walk, said method comprising the steps of:
providing a plurality of wheel assemblies, each of which comprises a wheel and a shock absorber; and
attaching at least one of said plurality of wheel assemblies to a location on said structure.

22. The method as set forth in claim 21 wherein each shock absorber in each wheel assembly comprises a robust shock absorber of a type employed on an off-road bicycle.
